(19) United States
(12) Patent Application Publication
(10) Pub. No.: US 2010/0162366 A1
(43) Pub. Date: Jun. 24, 2010

(54) APPARATUS AND METHOD OF PROTECTING PRIVATE INFORMATION IN DISTRIBUTED NETWORK

(75) Inventors: Weon Il JIN, Suwon-si (KR); Hwan Joon KIM, Seoul (KR)

Correspondence Address: North Star Intellectual Property Law, PC, P.O. Box 34688, Washington, DC, 20043, US

(73) Assignee: SAMSUNG ELECTRONICS CO., LTD., Suwon-si (KR)

(21) Appl. No.: 12/545,817

(22) Filed: Aug. 22, 2009

(30) Foreign Application Priority Data
Dec. 24, 2008 (KR) 10-2008-0133523

(51) Int. Cl. G06F 21/20

(52) U.S. Cl. 726/4

(57) ABSTRACT

Disclosed are methods and apparatus to protect private information in a distributed network. In the distributed network, a service request terminal may receive, from a service providing terminal, trust information related to a level of trust of the service providing terminal with respect to a desired service. Also, the service request terminal may verify whether to be provided with the desired service from the service providing terminal based on the trust information, thereby preventing private information of the service request terminal from being leaked. In addition, the service request terminal may easily verify the identity of the service providing terminal when the service request terminal re-visits the service providing terminal.

### CROSS-REFERENCE TO RELATED APPLICATION

This application claims the benefit under 35 U.S.C. §119(a) of Korean Patent Application No. 10-2008-0133523, filed on Dec. 24, 2008 in the Korean Intellectual Property Office, the entire disclosure of which is incorporated herein by reference.

### BACKGROUND

1. Field

The following description relates to techniques, method, and apparatus to protect private information in a distributed network.

2. Description of Related Art

Interest in Peer-to-Peer (P2P) communication, an Ad-hoc network, and the like between the mobile devices has grown with the increased use of various mobile devices such as a cellular phone, a personal digital assistant (PDA), and the like. In addition, with increased use of these devices and communications there arises a need for techniques that may cope with phishing attacks, such as stealing private information of service requesters from the distributed network by masquerading as legitimate service providers, the spreading of malware, and the like.

However, it is difficult to build an infrastructure to facilitate authentication of the service provider and the service requester in such distributed networks. Moreover, it is inefficient to use a trusted third party to authenticate the service provider and the service requester in the distributed network. For example, mobile devices may be dynamically connected with each other in the Ad-hoc network whereby an authentication with respect to the mobile devices relying on the trusted third organization may cause problems.

Also, in a general network, the service provider may authenticate the service requester, and the service provider may provide services to the service requester when an authentication with respect to the service requester is accepted. However, this may not completely protect private information of the service requester from being leaked to unauthorized parties.

Thus, there is a need to develop techniques that may be more effectively applicable to a distributed network, and better protect the private information of the service requester to cope with phishing attacks and attempts to illicitly obtain this information.

### SUMMARY

According to example embodiments, there may be provided a method of protecting private information of a service request terminal in a distributed network. The method includes: requesting a service providing terminal to provide trust information associated with a level of trust of the service providing terminal with respect to a desired service; receiving the trust information from the service providing terminal; and determining whether to be provided with the desired service from the service providing terminal based on the trust information.

In this instance, the service providing terminal may determine the level of trust of the service providing terminal with respect to the desired service based on a history of the service providing terminal in the providing of the desired service, and generate the trust information based on the determined level of trust.

Also, the method may further include: storing at least one random number of the service providing terminal, the at least one random number being previously received; and determining whether the service request terminal has previously visited the service providing terminal using the at least one random number of the service providing terminal.

According to example embodiments, there may be also provided an apparatus of protecting private information of a service providing terminal in a distributed network. The apparatus includes: a request receiving unit to receive, from a service request terminal, a request of trust information associated with a level of trust of the service providing terminal with respect to an desired service; a trust information generation unit to determine the level of trust based on a history of the service providing terminal in the providing of the desired service, and to generate the trust information based on the determined level of trust; and an information transmission unit to transmit the generated trust information to the service request terminal, wherein the trust information generation unit is implemented to prevent the trust information from being externally forged.

According to example embodiments, there may be further provided a method of protecting private information of a service providing terminal in a distributed network. The method includes: receiving, from a service request terminal, a request of trust information associated with a level of trust of the service providing terminal with respect to an desired service; determining the level of trust based on a history of the service providing terminal in the providing of the desired service, and generating the trust information based on the determined level of trust; and transmitting the generated trust information to the service request terminal.

Other features and aspects will be apparent from the following detailed description, the drawings, and the claims.

### BRIEF DESCRIPTION OF THE DRAWINGS

FIG. 1 is a diagram illustrating an example of mobile terminals performing a conventional Ad-hoc communication or Peer-to-Peer (P2P) communication in a distributed network.

FIG. 2 is a diagram illustrating an example of a process of determining whether a service request terminal is provided with services using trust information of a service providing terminal.

FIG. 3 is a block diagram illustrating an example of an apparatus of protecting private information of a service providing terminal.

FIG. 4 is an operational flowchart illustrating an example of a method of protecting private information of a service request terminal.

FIG. 5 is a diagram illustrating an example of a process where a service request terminal verifies a service providing terminal when the service request terminal re-visits the service providing terminal.

FIG. 6 is a diagram illustrating an example of a process where a service request terminal and a service providing terminal exchange random numbers.

Throughout the drawings and the detailed description, unless otherwise described, the same drawing reference numerals refer to the same elements and structures. The relative size and depiction of these elements may be exaggerated for clarity and convenience.

### DETAILED DESCRIPTION

The following detailed description is provided to assist the reader in gaining a comprehensive understanding of the media, apparatuses, methods and/or systems described herein. Accordingly, various changes, modifications, and equivalents of the systems, methods, apparatuses and/or media described herein will be suggested to those of ordinary skill in the art. Also, descriptions of well-known functions and constructions may be omitted for increased clarity and conciseness.

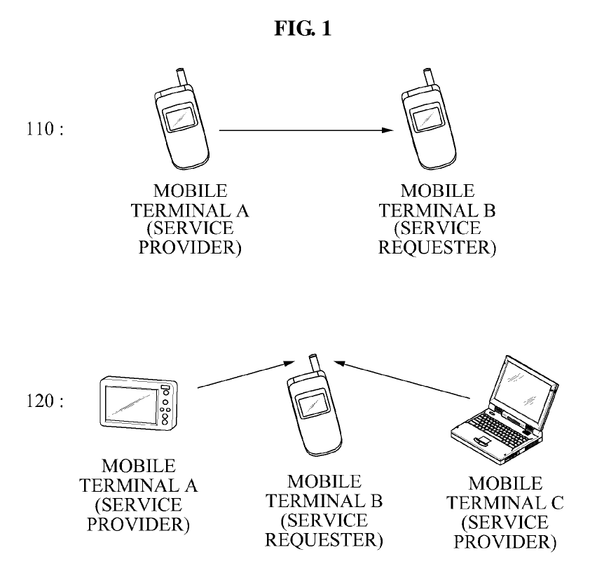

FIG. 1 is a diagram illustrating an example of mobile terminals performing a conventional Ad-hoc communication or Peer-to-Peer (P2P) communication in a distributed network. As shown in configuration 110, a mobile terminal A is a service provider providing services, and a mobile terminal B is a service requester receiving services. As shown in configuration 120, a mobile terminal B is a service requester, and mobile terminals A and C provide services to the mobile terminal B.

Mobile devices may not be controlled by a separate node, and may be dynamically connected with each other to perform the conventional Ad-hoc communication or P2P communication.

It may be inefficient to build an infrastructure using a trusted third organization so as to authenticate the service provider and the service requester in such a distributed network, as shown in FIG. 1. Also, verification of the service provider by the service requester using a separate black list may adversely affect service even though the intent is to effectively cope with or prevent phishing attacks.

Also, a general network may have a structure in which the service provider authenticates the service requester. For example, in the general network, the service requester may provide his or her own private information or authentication information to the service provider, and the service provider may determine whether to provide services to the service requester based on the private information and authentication information of the service requester. In this manner, the private information and authentication information of the service requester may be exposed when provided to the service provider.

Accordingly, there arises a need for techniques of securely providing Ad-hoc communication and P2P communication without building a separate infrastructure, while preventing the private information of the service requester from being exposed when provided to the service provider.

One method of protecting private information may include determining whether the service requester is provided with services from the service provider, which is different from whether the service provider provides services to the service requester. According to this method, the service requester does not expose his or her own private information regardless of whether the service requester is provided with the services from the service provider.

Also, the method of protecting private information according to examples herein may have a configuration where the service requester actively verifies the service provider using ‘trust information’ while not relying on the separate infrastructure.

The above-mentioned examples are further described in detail below.

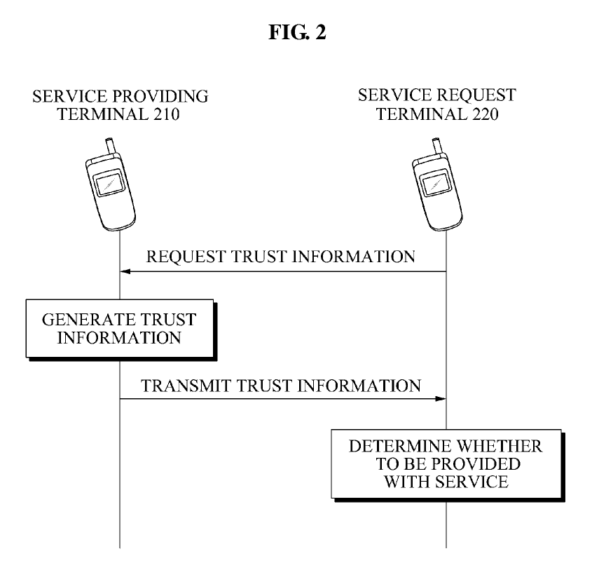

FIG. 2 is a diagram illustrating an example of a process of determining whether a service request terminal 220 is provided with services using trust information of a service providing terminal 210. Referring to FIG. 2, the service request terminal 220 may request trust information to determine whether to be provided with services from the service providing terminal 210. Here, the trust information may include information concerning a level of trust of the service providing terminal 210.

Also, the service providing terminal 210 may determine its own level of trust based on a history with respect to the providing of the services. In this instance, the level of trust may be prevented from being forged even by the service providing terminal 210 itself. For example, the service providing terminal 210 may include a module for determining a level of trust, such as an aircraft Black Box-like module.

Also, the service providing terminal 210 may use various types of factors to determine the history with respect to the providing of the services. That is, the service providing terminal 210 may determine its own level of trust with respect to a corresponding service based on a period of time during which the corresponding service is provided to other users by the service providing terminal 210, evaluations of the other users with respect to the corresponding service, and the like. For example, in a case where the service providing terminal 210 provides the corresponding service to the other users for a relatively long period of time, or the evaluations of the other users with respect to the corresponding service are good, the level of trust of the service providing terminal 210 with respect to the corresponding service may be determined to be high. In addition, as the number of times the service providing terminal 210 has recently provided the corresponding service increases, the level of trust of the service providing terminal 210 with respect to the corresponding service may be determined to be higher.

Also, the level of trust determined by the service providing terminal 210 may have various values. For example, the level of trust may be evaluated to be any one of a series of values from 1-10, with a first level being a highest level of trust to a tenth level being a lowest level of trust.

Also, the service providing terminal 210 may transmit, to the service request terminal 220, trust information generated based on its own level of trust with respect to a corresponding service.

In this instance, the service request terminal 220 may ascertain a level of trust of the service providing terminal 210 based on the trust information, and determine whether to accept services from the service providing terminal 210. Particularly, the service request terminal 220 may compare the level of trust of the service providing terminal 210 and a predetermined threshold level to determine whether to accept the services provided from the service providing terminal 210. For example, when the threshold level is a fourth level, the service request terminal 220 is provided with the services from the service providing terminal 210 only in cases of first, second, third, and fourth levels of the level of trust, and is not be provided with the services from the service providing terminal 210 in cases of fifth level to tenth level of the level of trust.

Consequently, the service request terminal 220 may determine by itself whether to accept services provided from the service providing terminal 210 using the level of trust of the service providing terminal 210. As a result, private information of the service request terminal 220 may be prevented from being unnecessarily exposed. In addition, because a separate trusted organization is not needed, the private information may be effectively and efficiently protected.

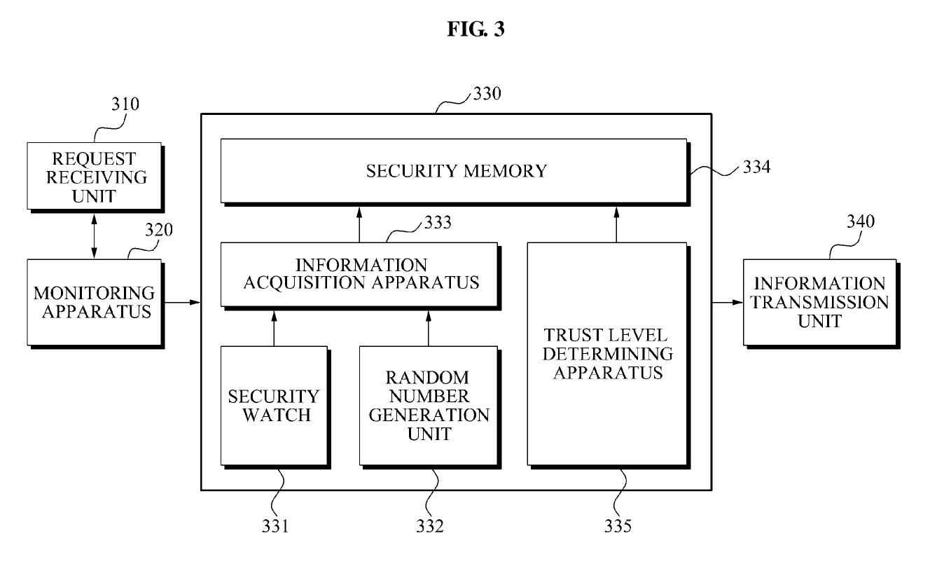

FIG. 3 is a block diagram illustrating an example of an apparatus to protect private information of a service providing terminal. Referring to FIG. 3, the apparatus to protect private information includes a request receiving unit 310, a monitoring apparatus 320, a trust information generation unit 330, and an information transmission unit 340.

The request receiving unit 310 may receive, from a service providing terminal, a request of trust information associated with a level of trust of the service providing terminal for a corresponding service. Also, the monitoring apparatus 320 may monitor a service start signal and a service end signal of the service providing terminal, an identifier of the corresponding service, and evaluations of the corresponding service. The request of the trust information and monitoring results may be provided to the trust information generation unit 330.

Also, the trust information generation unit 330 may determine a level of trust with respect to a corresponding service of the service providing terminal in response to the request for the trust information, and generate trust information based on the level of trust. In this instance, the trust information generation unit 330 may be implemented to prevent the level of trust from being externally forged, even by the service providing terminal itself.

In one example, the trust information generation unit 330 includes a security watch 331, a random number generation unit 332, an information acquisition apparatus 333, a security memory 334, and a level of trust determining apparatus 335.

The security watch 331 may be a watch prevented from being externally forged, and may measure a service start time, a service end time, a service continuous time, and the like. Time-related information measured by the security watch 331 may be stored in the security memory 334 through the information acquisition apparatus 333.

Also, the random number generation unit 332 may generate random numbers used to verify the service providing terminal when the service request terminal re-visits the service providing terminal, which is described in detail below.

Also, the information acquisition apparatus 333 may acquire the time-related information measured by the security watch 331, the random numbers generated by the random number generation unit 332, and evaluations with respect to the services provided from the monitoring apparatus 320.

Also, the security memory 334 may store a history of the service providing terminal with respect to a corresponding service. Here, the history may include evaluations with respect to the corresponding services, a service start time, a service end time, a continuous service time, a previously determined level of trust with respect to the corresponding service, and the like. In this instance, the security memory 334 may store a separate history for each of the services.

Also, the level of trust determining apparatus 335 may determine a level of trust based on the history of the service providing terminal with respect to the corresponding service. Particularly, as the number of times the service providing terminal has recently provided the corresponding service increases, the evaluations with respect to the service providing terminal in association with the corresponding service becomes better, and as a time during which the service providing terminal continuously provides the corresponding service increases, the level of trust becomes higher.

For example, assume that the evaluations with respect to the service providing terminal in association with the corresponding service is any one of “good” or “bad,” and Y is a year when the service providing terminal starts to provide the corresponding service. Also, assume that D is the number of times, for example, the number of days, the service providing terminal provides the corresponding service in one month. In this instance, the level of trust determining apparatus 335 may determine the level of trust based on Equation 1, which is represented as:

Level of trust=0.2*Max[10, this year−Y]/10+0.5*D/30+0.3*[number of “good”'s]/[a number of “bad”'s] [Equation 1]

Consequently, the trust information generation unit 330 may calculate the level of trust of the service providing terminal with respect to the corresponding service, and generate the trust information based on the calculated level of trust. Also, the trust information may be provided to the service request terminal by the information transmission unit 340. In this instance, the service request terminal may determine whether to receive the corresponding service from the service providing terminal based on the trust information.

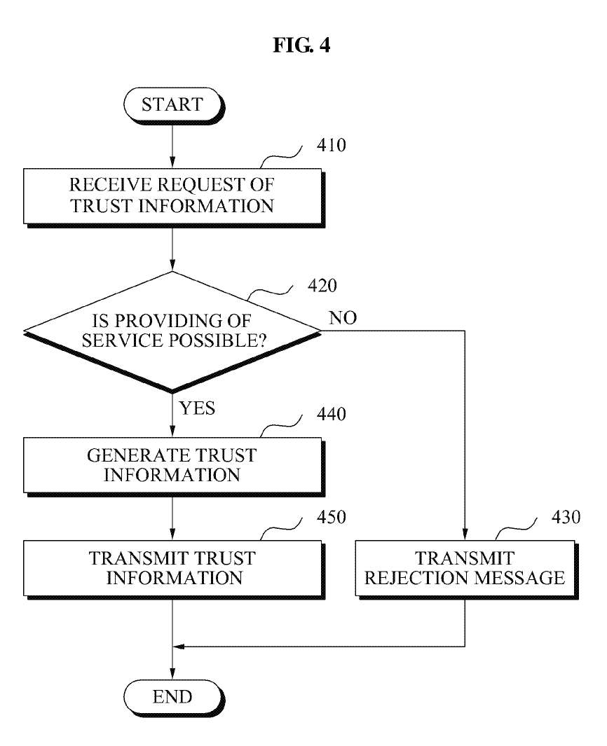

FIG. 4 is an operational flowchart illustrating an example of a method of protecting private information of a service request terminal. Referring to FIG. 4, in operation 410, the service providing terminal may receive a request for trust information from the service request terminal. Here, the service providing terminal and the service request terminal may perform Ad-hoc communication or P2P communication in a distributed network.

In operation 420, the service providing terminal may determine whether to provide a corresponding service. In operation 430, when it is impossible to provide the corresponding service, the service providing terminal may transmit a rejection message.

In operation 440, when the service may be provided, the service providing terminal may generate trust information. That is, the service providing terminal may calculate a level of trust based on a history related to providing the corresponding service, and generate the trust information based on the calculated level of trust. Here, the level of trust may be prevented from being externally forged.

In operation 450, the service providing terminal may provide the generated trust information to the service request terminal. In this instance, the service request terminal may determine whether to accept provision of the corresponding service from the service providing terminal based on the trust information.

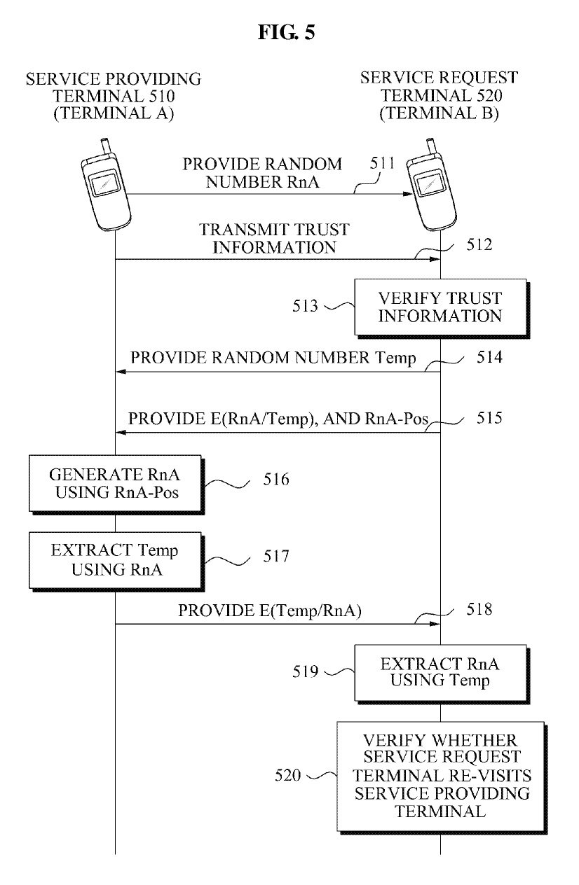

FIG. 5 is a diagram illustrating an example of a process where a service request terminal (terminal B) 520 verifies a service providing terminal (terminal A) 510 when the service request terminal re-visits the service providing terminal. Referring to FIG. 5, in operation 511, the service providing terminal (terminal A) 510 may provide a random number RnA to the service request terminal (terminal B) 520.

In operation 512, the service providing terminal 510 may transmit trust information to the service request terminal 520. The service providing terminal 510 may provide the random number RnA to the service request terminal 520 before transmitting the trust information as illustrated in FIG. 5, or the service providing terminal 510 may provide the random number RnA to the service request terminal 520 in a process of transmitting the trust information or even after transmitting the trust information, unlike the example being illustrated in FIG. 5.

In operation 513, the service request terminal 520 may verify the trust information and determine to be provided with or accept the corresponding service from the service providing terminal 510 based on the trust information.

After the service request terminal 520 initially verifies the trust information, and re-visits the service providing terminal 510, the service request terminal 520 may determine whether to be provided with the corresponding service from the service providing terminal 510 without re-receiving the trust information from the service providing terminal 510. Specifically, the service request terminal 520 may verify whether the service providing terminal 510 re-generates the random number RnA, and thereby simply determine whether the service providing terminal 510 is the actual “terminal A.” Also, the service request terminal 520 may determine whether to be provided with the service from the service providing terminal 510 based on the determined result.

In one example, in operation 514, the service request terminal 520 may generate a random number Temp, and provide the generated random number Temp to the service providing terminal 510.

In operation 515, the service request terminal 520 may encrypt the random number Temp using the random number RnA as an encryption key to thereby generate an E(RnA|Temp), and provide the E(RnA|Temp) to the service providing terminal 510. Because a random number generation unit of the service providing terminal 510 may generate a plurality of random numbers, the service request terminal 520 may provide, to the service providing terminal 510, an RnA-Pos indicating where a random number RnA of the plurality of random numbers is located.

In operation 516, the service providing terminal 510 may re-generate the random number RnA using the RnA-Pos. In operation 517, the service providing terminal 510 may extract the random number Temp from the E(RnA|Temp) using the RnA generated in operation 516 as a decoding key.

In operation 518, the service providing terminal 510 may encrypt the RnA generated in operation 516 using the random number Temp extracted as the encryption key in operation 517 to thereby generate an E(Temp|RnA), and provide the E(Temp|RnA) for sending to the service request terminal 520.

In operation 519, the service request terminal 520 may extract the random number RnA from the E(Temp|RnA) using the random number Temp as a decoding key.

In operation 520, the service request terminal 520 may compare the random number RnA extracted in operation 519 and the random number RnA provided in operation 511 to thereby verify whether the service request terminal 520 accepts services from the service providing terminal 510. Specifically, the service request terminal 520 may verify whether the service providing terminal 510 is still the actual “terminal A.”

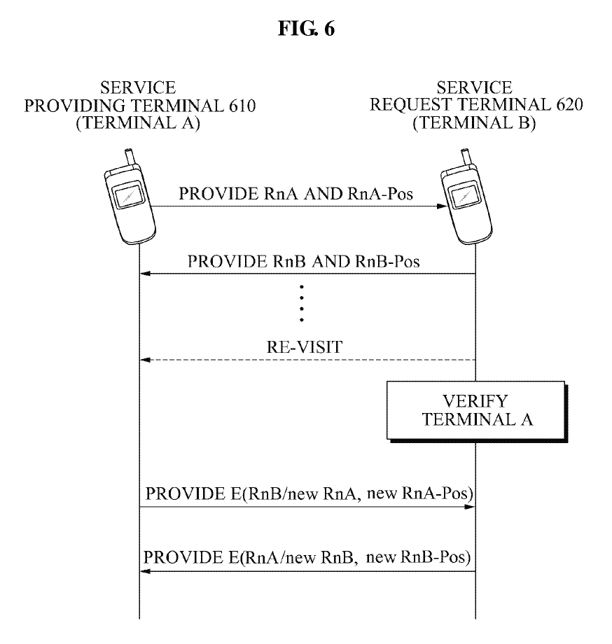

FIG. 6 is a diagram illustrating an example of a process where a service request terminal (terminal B) 620 and a service providing terminal (terminal A) 610 exchange random numbers.

In FIG. 6, it is assumed that the service providing terminal (terminal A) 610 and the service request terminal (terminal B) 620 exchange respective random numbers. In this instance, the exchanged of newly updated random numbers may be used rather than exchanging the previously maintained random numbers to thereby provide increased security.

According to one example, the service providing terminal 610 and the service request terminal 620 may securely exchange respective random numbers, and update the exchanged random numbers.

Here, it is assumed that the service providing terminal 610 provides random numbers RnA and RnA-Pos to the service request terminal 620, and the service request terminal 620 provides random numbers RnB and RnB-Pos to the service providing terminal 610 to thereby exchange the respective random numbers.

Thereafter, when the service request terminal 620 re-visits the service providing terminal 610, the service request terminal 620 may verify whether the service providing terminal 610 re-generates the RnA, as described in FIG. 5, to determine whether the service providing terminal 610 is the actual terminal A.

The service providing terminal 610 may encrypt new random numbers RnA and RnA-Pos using a currently stored random number RnB as an encryption key to thereby generate an E(RnB|new RnA, new RnA-Pos), and provide the E(RnB 1 new RnA, new RnA-Pos) to the service request terminal 620. In this instance, the service providing terminal 610 may provide the RnB-Pos to the service request terminal 620. Similarly, the service request terminal 620 may encrypt the new random numbers RnB and RnB-Pos using the previously stored random number RnA as an encryption key to thereby generate an E(RnA|new RnB, new RnB-Pos), and provide the E(RnA|new RnB, new RnB-Pos) to the service providing terminal 610. In this instance, the service request terminal 620 may provide the RnA-Pos to the service providing terminal 610.

In this instance, the service request terminal 620 may extract a new random number of a new RnA from the E(RnB|new RnA, new RnA-Pos), and extract a new random number of a new RnB from the E(RnA|new RnB, new RnB-Pos). Consequently, the service providing terminal 610 and the service request terminal 620 may securely exchange and update the respective random numbers.

Although not shown, the service requesting terminals described above may include a transmitter and receiver for exchanging information with the service providing terminals. In addition, the service requesting terminals may include a processing device and memory, and more specifically a random number generation unit, an encryption unit, and a trust level determining apparatus.

As described above, there are provided a method and apparatus of protecting private information, which may verify the identity and trust of the service provider using the trust information of the service provider, thereby providing anti-phishing techniques being suitable for a distributed network where implementation of an infrastructure for authenticating the service provider using a trusted third organization is difficult. As a result, trusted third organization may not be needed, thereby providing an effective and efficient alternative to coping with phishing attacks.

The service requester may verify the service provider using the trust information of the service provider, thereby preventing private information of the service requester from being unnecessarily leaked. Here, the trust information of the service provider does not need to have any connection with the private information of the service requester.

Also, a separate black list for anti-phishing does not be used, thereby easily coping with new types of phishing attacks in way that is more robust than current methods.

Also, when the service requester re-visits the same service provider, the service requester may easily verify the actual identity of the service provider.

The methods described above may be recorded, stored, or fixed in one or more computer-readable media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules or units in order to perform the operations and methods described above, or vice versa.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of protecting private information of a service request terminal in a distributed network, the method comprising:
requesting a service providing terminal to provide trust information associated with a level of trust of the service providing terminal with respect to a service provided by the service providing terminal;
receiving the trust information from the service providing terminal; and
determining whether to be provided with the service from the service providing terminal based on the trust information.

2. The method of claim 1, wherein determining whether to be provided with the service includes determining whether to be provided with the service depending on the level of trust of the service providing terminal with respect to the service as ascertained based on the trust information.

3. The method of claim 1, wherein determining whether to be provided with the service includes comparing the level of trust of the service providing terminal with respect to the service as ascertained based on the trust information with a predetermined threshold level to determine whether to be provided with the service.

4. The method of claim 1, wherein receiving the trust information from the service providing terminal includes receiving the trust information based on the level of trust of the service providing terminal with respect to the service that is determined based on a history of the service providing terminal in the providing the service.

5. The method of claim 1, wherein receiving the trust information from the service providing terminal includes receiving the trust information generated based on at least one of a time when providing of the service is started, a time when providing of the service is terminated, and a user evaluation with respect to the service provided by the service providing terminal.

6. The method of claim 1, wherein receiving the trust information from the service providing terminal includes receiving the trust information generated by the service providing terminal to prevent external forgery of the trust information.

7. The method of claim 1, further comprising:
storing at least one previously received random number from the service providing terminal; and
determining whether the service request terminal has previously visited the service providing terminal using the at least one random number received from the service providing terminal.

8. The method of claim 7, wherein determining whether the service request terminal has previously visited the service providing terminal includes determining whether the service request terminal has previously visited the service providing terminal based on whether the service request terminal is able to determine whether the service providing terminal correctly re-generates the at least one random number.

9. An apparatus of protecting private information of a service providing terminal in a distributed network, the apparatus comprising:
a request receiving unit to receive, from a service request terminal, a request of trust information associated with a level of trust of the service providing terminal with respect to a desired service;
a trust information generation unit to determine the level of trust based on a history of the service providing terminal in the providing of the desired service, and to generate the trust information based on the determined level of trust; and
an information transmission unit to transmit the generated trust information to the service request terminal,
wherein the trust information generation unit is configured to prevent external forgery of the trust information.

10. The apparatus of claim 9, wherein the trust information is configured to allow the service request terminal to determine whether to be provided with the desired service from the service providing terminal.

11. The apparatus of claim 9, wherein the trust information generation unit includes:
a security watch to calculate a time when providing of the desired service is started or a time when providing of the desired service is terminated;
a random number generation unit to generate at least one random number corresponding to the service providing terminal;
an information acquisition apparatus to acquire information about user evaluations with respect to the desired service provided by the service providing terminal or information about the start or termination times; and
a level of trust determining apparatus to determine the level of trust based on the acquired information.

12. The apparatus of claim 11, wherein the at least one random number is configured to indicate whether the service request terminal has previously visited the service providing terminal.

13. A method of protecting private information of a service providing terminal in a distributed network, the method comprising:
receiving, from a service request terminal, a request of trust information associated with a level of trust of the service providing terminal with respect to an desired service;
determining the level of trust based on a history of the service providing terminal in the providing of the desired service, and generating the trust information based on the determined level of trust; and
transmitting the generated trust information to the service request terminal.

14. The method of claim 13, wherein generating the trust information includes generating trust information configured to allow the service request terminal to determine whether to be provided with the desired service from the service providing terminal.

15. The method of claim of claim 13, wherein the generating of the trust information includes:
calculating a time when providing of the desired service is started or a time when providing of the desired service is terminated;
generating at least one random number corresponding to the service providing terminal;
acquiring information about user evaluations with respect to the desired service provided by the service providing terminal or information about the start or termination times; and
determining the level of trust based on the acquired information.

16. A computer readable medium storing instructions configured to cause a computer to:
request a service providing terminal to provide trust information associated with a level of trust of the service providing terminal with respect to a service provided by the service providing terminal;
receive the trust information from the service providing terminal; and
determine whether to be provided with the service from the service providing terminal based on the trust information.
